(19) United States
(12) Patent Application Publication
(10) Pub. No.: US 2007/0137235 A1
(43) Pub. Date: Jun. 21, 2007

(54) Arrangement for cooling components in a vehicle

(75) Inventors: Thomas Heck, Mainz-Laubenheim (DE); Winfried Moll, Laubach (DE); Horst Pieper, Hosbach (DE)

Correspondence Address: MORRISON & FOERSTER LLP, 1650 TYSONS BOULEVARD, SUITE 400, MCLEAN, VA, 22102, US

(73) Assignee: Siemens Aktiengesellschaft, Munchen (DE)

(21) Appl. No.: 11/386,107

(22) Filed: Mar. 22, 2006

(30) Foreign Application Priority Data
Mar. 23, 2005 (DE) 10 2005 013 567.6

(51) Int. Cl. B60H 1/00; F25D 23/12; B60H 1/32

(52) U.S. Cl. 62/259.2; 165/202; 62/239

(57) ABSTRACT

The invention relates to an arrangement for cooling a component in a vehicle with a device for providing cool air, with at least one air supply device for feeding the cool air into a passenger compartment of the vehicle, and with a first air-guiding element which branches off from the air supply device before it reaches the passenger compartment, conducts part of the cool air away from the air supply device and guides it to the component to be cooled. According to the invention, an air suction device conducts air away from the component.

### CLAIM FOR PRIORITY

This application claims the benefit of priority to German Application No. 10 2005 013 567.6, filed in the German language on Mar. 23, 2005, the contents of which are hereby incorporated by reference.

### TECHNICAL FIELD OF THE INVENTION

The invention relates to an arrangement for cooling a component in a vehicle, and in particular, having a device for providing cool air.

### BACKGROUND OF THE INVENTION

U.S. Pat. No. 5,481,885 discloses a ventilation system for that region of a motor vehicle dashboard which is part of a conventional ventilation or air conditioning system. An air pipe branches off cool air from a main air flow produced by a fan and conducts it to electronic components, for example the audio system.

In modern vehicles which not only comprise passenger vehicles but also trucks or ships, more and more electronic devices are used which are intended to assist the vehicle driver in his task and to increase the comfort of the vehicle driver and other passengers. Thus, for example, in addition to information devices, such as navigation system, distance warning device and onboard computer, conversation systems with audio and video devices are also installed in the vehicles. In each case only the display and operating units of the devices are visible to the passengers, while the other electric and electronic components generally disappear into insertion shafts and behind panels. In order to remove the heat inevitably generated by the electronic components, heat sinks or ventilators are nowadays customarily fitted directly on or in the vicinity of these components.

However, as a result, the removal of heat is not always ensured to a sufficient extent, which, in particular in the case of heat-sensitive components, such as CD and DVD drives, has an effect on their operational reliability.

In addition, ventilator noises are frequently found annoying. By contrast, the supply of additional cool air according to SUMMARY OF THE INVENTION

The present invention improves upon the arrangement discussed at the beginning such that actual cooling of the component can be ensured.

One embodiment of the invention relates to an arrangement for cooling a component in a vehicle, and in particular, having a device for providing cool air, with at least one air supply device for feeding the cool air into a passenger compartment of the vehicle, and with a first air-guiding element which branches off from the air supply device before it reaches the passenger compartment, conducts part of the cool air away from the air supply device and guides it to the component to be cooled.

The invention is based on the finding that, in particular in the cockpit region of vehicles, in which the construction space is restricted due to the multiplicity of devices arranged behind the panels, due to the high packing density there is a problem with the removal of the heat generated by the electronics. In such a case, heat sinks and ventilators are only of little use and the additionally supplied cooled air also scarcely has the correct effect if, after the component has output its own heat to it, it simply swirls with cool air flowing downstream. In order to provide a remedy, the invention proposes to provide an air suction device which conducts air away from the component to be cooled. This generates an air flow which carries along the hot air from the component with it. With a simultaneous supply of cool air, i.e. air whose temperature is lower than the temperature of the component, it is ensured, by means of a first air-guiding element, that the component can permanently output heat to the cool air and that the heated air is consistently transported away. A component to be cooled is understood as meaning, in addition to an electronic component already mentioned, also a component which is adjacent to electronic devices and therefore absorbs their lost heat, for example a wall or a storage compartment in the cockpit region. The cool air can be provided via a fan for sucking in cool air from the area outside the vehicle or else by an air conditioning compressor.

In order to ensure the greatest possible transfer of heat to the supplied cool air, in a development it is proposed that the air suction device and the first air-guiding element are arranged on the same side of the component and are spaced apart from each other. By means of the arrangement on the same side of the component, a flow is generated along a surface of the component, i.e. it is ensured that the supplied cool air flows along this surface, in the process absorbs heat and, after reaching the air suction device or in the vicinity thereof, is transported away again. The larger the region of the surface situated between the first air-guiding element and the air suction device, the more heat can be output to the cool air, provided that the temperature of the cool air is low enough and the air suction device is arranged and designed in such a manner that the supplied air is reliably picked up by the suction flow.

The air suction device may be an extractor in conjunction with an air removal pipe which reaches into the passenger compartment or into the area outside the vehicle and is arranged in the vicinity of the component to be cooled. However, in a preferred refinement of the invention, the air suction device is formed just by a second air-guiding element which is connected to the air supply device between the passenger compartment and the first air-guiding element. A flow in the direction of the passenger compartment prevails in the air supply device. As seen downstream, cool air is branched off from this flow by means of the first air-guiding element and, after it has been heated by the component, is subsequently supplied again to the flow by means of the second air-guiding element. In the case of this refinement, an active suction element, such as a fan, can be omitted, since in this case the suction effect caused by the flow in the air supply device is used. This is because the flow causes a negative pressure in the second air-guiding element, in the vicinity of the connecting point to the air supply device, the negative pressure ensuring a continuous flow downstream of the air entering the second air-guiding element on the component side. In addition to saving on an active suction element, this preferred refinement affords further advantages. An additional removal pipe and therefore opening into the passenger compartment or the area outside the vehicle is not required, since the branched-off air is simply supplied again to the original air flow. The configuration of panels and coverings in the vehicle therefore remains unaffected by the cooling arrangement. Furthermore, air conditioning systems nowadays are usually produced from plastic by injection molding. The fitting of additional air guides to the main air pipe of the air supply device does not require a further working step here, i.e. it constitutes a solution which is reasonably priced to produce.

In an advantageous embodiment, the cross section of the air supply device is virtually constant in the region upstream and downstream of the connection to the second air-guiding element. The suction effect is thereby further reinforced, since the velocity of the flow after addition of the branched-off part of the air is increased owing to the constant cross section.

In order to ensure a maximum possible removal of heat at the component, in a development of the invention use is always made of the coolest air of an air conditioning system or of a ventilation system of the vehicle, which is achieved by the arrangement of the first air-guiding element upstream of a heating device serving to heat the cool air and/or behind an active cooling element, for example an air conditioning compressor, in each case is viewed downstream of the air supply device. The cool air can therefore be produced either by a simple intake of outside air or else by active cooling of air. In both cases, this coolest air is used for feeding to the component. A heating device for heating the air is arranged downstream of the branching off of the air by the first air-guiding element.

Since an overheating in the region of the component may occur even in the case of cooler outside temperatures, if an active cooling element or an air conditioning system in the vehicle is not switched on, in a further refinement it is provided that a monitoring device monitors the temperature of the component and activates the active cooling element or the air conditioning system when a predetermined threshold value is exceeded. In this case, the monitoring unit may be an independent logic unit or else part of the component to be cooled or part of the air conditioning system.

### BRIEF DESCRIPTION OF THE DRAWINGS

The invention is explained in more detail below with reference to an exemplary embodiment and the drawing.

FIG. 1 shows an air conditioning system in a motor vehicle.

### DETAILED DESCRIPTION OF THE INVENTION

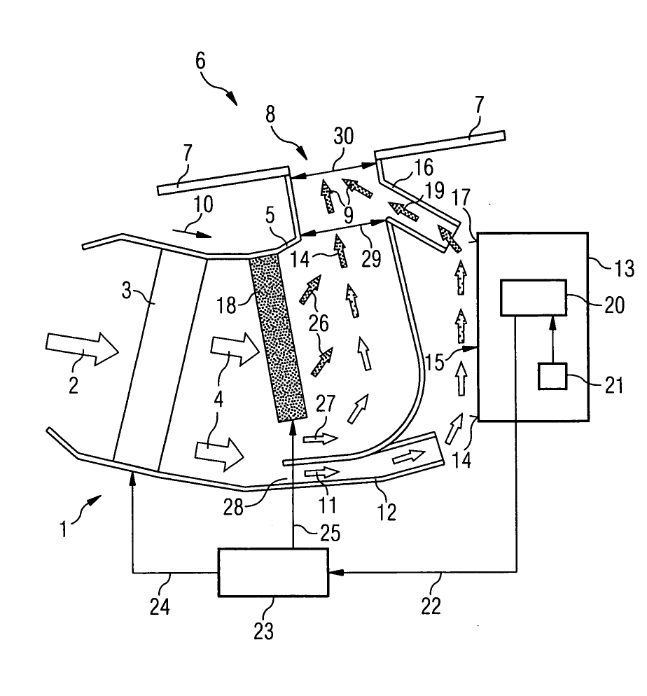

FIG. 1 shows an air conditioning system 1 in a motor vehicle, comprising an air conditioning control 23, a supply device 5, an air conditioning compressor 3 and a heater 18. The air conditioning control 23 controls the operation of the air conditioning compressor 3 and of the heater 18 via the control lines 23 and 25. A temperature sensor 21 is fitted in or on an electronic component 13 to be cooled, the temperature sensor detecting the temperature of the component 13 and outputting it to a monitoring unit 20 belonging to the component 13. In the case of operation illustrated in the figure, the temperature detected by the sensor 21 has exceeded a threshold value, i.e. overheating is threatened for the component 13. Accordingly, the monitoring unit 20 activates the air conditioning control 23 via a control bus 22, for example a CAN bus, and therefore switches on the air conditioning system 1. Air 2 sucked in from an area outside the vehicle or recovered from a passenger compartment 6 via a recirculating air circuit is now cooled by means of the air conditioning compressor 3, as a result of which the cool air 4 is produced. This is conveyed via an air supply device 5 in the direction of the passenger compartment 6 which is situated behind a panel 7. An opening 8 through which an air flow 9 passes is made in the panel 7. In order to bring the cool air 4 to the temperature desired for air conditioning the passenger compartment 6, part of the cool air 4 is also conducted through a heater 18, thus resulting in the heated air 14 which is composed of a heated air part 26 and a cool air part 27. The flow direction 10 of the air flowing in the air supply device 5 is additionally clarified by the points of the arrows illustrating the individual air flows 2, 4, 26, 27, 14 and 9. From the overall amount of cool air 4, part 11 is branched off via a first air-guiding element 12 and conveyed into the vicinity of a component 13 to be cooled. The branching-off 28 of the first air-guiding element 12 from the air supply device 5 is situated, as seen in the flow direction 10, upstream of the heater 5 and downstream of the air conditioning compressor 3.

The cool air 11 strikes against a first end 14 of a side 15 of the component 13. It flows along the side 15 of the component 13 or along that surface of the component 13 which belongs to this side 15 and absorbs the heat output via the side 15, as a result of which the cool air 11 is converted into the heated air 19. A second air-guiding element 16 begins in the vicinity of a second end 17 of the side 15 of the component 13. It picks up the heated air 19 from there and feeds it to the air flow 14 in the air supply device 5, from which the air 9 flowing into the passenger compartment 6 is produced. The air flow 14 here moves at a higher velocity than the air 19, since it is moved in the direction of the passenger compartment 6 in a targeted manner, generally by means of a fan (not illustrated here). Owing to this higher velocity, a negative pressure is produced at that end of the second air-guiding element 16 which opens into the air supply device 5, the negative pressure ensuring that the air 19 or the air 11 which is still cool is sucked in. A flow is therefore forced along the side 15 of the component 13 without an additional fan being used. Furthermore, the cross section 29 of the air supply device 5 in the region upstream of the second air-guiding element 16 is the same size as the cross section 30 of the air supply device 5 in the region downstream of the second air-guiding element 16. This causes the velocity of the air flow 9 to rise in relation to the velocity of the air flow 14, which reinforces the suction effect in the second air-guiding element 16.

What is claimed is:

1. An arrangement for cooling a component in a vehicle, comprising:
a device providing cool air;
at least one air supply device feeding the cool air into a passenger compartment of the vehicle;
a first air-guiding element which branches off from the air supply device before it reaches the passenger compartment, conducts part of the cool air away from the air supply device and guides it to the component to be cooled; and
an air suction device conducts air away from the component.

2. The arrangement as claimed in claim 1, wherein the air suction device and the first air-guiding element are arranged on a same side of the component and are spaced apart from each other.

3. The arrangement as claimed in claim 1, wherein the air suction device is formed by a second air-guiding element which is connected to the air supply device between the passenger compartment and the first air-guiding element.

4. The arrangement as claimed in claim 3, wherein a cross section of the air supply device is approximately constant in a region upstream and downstream of the connection to the second air-guiding element.

5. The arrangement as claimed in claim 1, wherein the first air-guiding element branches off from the air supply device upstream of a heating device serving to heat the cool air.

6. The arrangement as claimed in claim 1, wherein the first air-guiding element branches off from the air supply device behind an active cooling element.

7. The arrangement as claimed in claim 6, wherein there is a monitoring device which processes the temperature of the component and switches on the active cooling element when a predetermined threshold value is exceeded.

8. The arrangement as claimed in claim 7, wherein the active cooling element is part of an air conditioning system and the monitoring device activates the air conditioning system when the threshold value is exceeded.
